(19) United States
(12) Patent Application Publication
(10) Pub. No.: US 2026/0073556 A1
(43) Pub. Date: Mar. 12, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuto YOSHIDA, Kanagawa (JP)

(21) Appl. No.: 19/322,868

(22) Filed: Sep. 9, 2025

(30) Foreign Application Priority Data
Sep. 11, 2024 (JP) 2024-157695

(51) Int. Cl. G06T 7/73; G06T 15/20

(52) U.S. Cl. CPC G06T 7/73; G06T 15/20; G06T 2207/20081

(57) ABSTRACT

Parameters in a learning model to represent spatial information are set appropriately. An image processing apparatus 100 according to the present disclosure obtains a plurality of images obtained by image-capturing a three-dimensional space containing an object from multiple directions, analyzes the images to obtain an image feature related to each of the images, obtains position information indicating a position of the object, and sets parameters in a learning model to estimate spatial information related to a training region contained in the three-dimensional space, based on the position information and the image feature.

### BACKGROUND

### Field of the Technology

The present disclosure relates to a technique for estimating spatial information from captured images obtained by image-capturing from multiple viewpoints.

### Description of the Related Art

There is a spatial information estimation technique capable of generating a virtual viewpoint image representing a view from any virtual point of view (hereinafter referred to as a “virtual viewpoint”) based on captured images obtained by image-capturing from multiple viewpoints and camera parameters set for the image-capturing. U.S. Patent Application Publication No. 2022/0036602 (hereinafter referred to as Patent Document 1) discloses a spatial information estimation method as described below. First, a learning model is given information on the position and direction of an image-capturing viewpoint to estimate color information of each pixel, and then compares the estimated color information of the pixel with color information of a pixel in the captured image that corresponds to that pixel. Next, the learning model is trained by feeding back an error between the color information pieces to spatial information, thereby generating the spatial information conforming to the captured image. In the estimation method disclosed in Patent Document 1, the more the number of parameters representing colors or densities in a space of the learning model configured to estimate spatial information (hereinafter referred to as “the spatial information parameter number”), the more complex the spatial information that can be represented. Specifically, for example, in a case where a learning model uses a deep neural network (DNN) to represent the spatial information, the number of layers and the number of nodes in the DNN are regarded as the spatial information parameter number.

### SUMMARY

The present inventor found that in a case where the spatial information parameter number is excessively large, the number of variables to be optimized is also excessively large, which requires an enormous amount of calculation for learning. In addition, the present inventor found that in a case where the spatial information parameter number is too small for an object to be represented by spatial information, sufficient learning accuracy cannot be obtained and the representation of the object contained in a virtual viewpoint image may be blurred. Based on these findings, the present inventor realized that in order to achieve sufficiently accurate learning with a smaller amount of calculation, it is necessary to set the spatial information parameter number in a learning model appropriately according to an object to be represented by spatial information.

An image processing apparatus according to the present disclosure includes one or more hardware processors; and one or more memories storing one or more programs configured to be executed by the one or more hardware processors, the one or more programs including instructions for: obtaining a plurality of images obtained by image-capturing a three-dimensional space containing an object from a plurality of directions; analyzing the images to obtain an image feature related to the each of the images; and setting a parameter in a learning model to estimate spatial information related to a training region contained in the three-dimensional space, based on the position information and the image feature.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of logical constituents in an image processing apparatus according to a first embodiment.

FIG. 2 is a block diagram illustrating an example of a hardware configuration of the image processing apparatus according to the first embodiment.

FIG. 3 is a flowchart presenting an example of a processing flow in the image processing apparatus according to the first embodiment.

FIGS. 4A to 4C are diagrams for explaining an example of obtaining processing in a feature obtaining unit according to the first embodiment.

FIG. 5 is a diagram for explaining an example of obtaining processing in a position obtaining unit according to the first embodiment.

FIG. 6 is a diagram for explaining spatial resolution estimation processing in a setting unit according to the first embodiment.

FIGS. 7A and 7B are diagrams for explaining an example of volume rendering processing in a training unit according to the first embodiment.

FIGS. 8A to 8C are diagrams for explaining an example of obtaining processing in a position obtaining unit according to Modification 1 of the first embodiment.

FIGS. 9A to 9D are diagrams for explaining an example of obtaining processing in a feature obtaining unit according to Modification 2 of the first embodiment.

FIG. 10 is a flowchart presenting an example of a processing flow in an image processing apparatus according to a second embodiment.

FIGS. 11A to 11D are diagrams for explaining an example of obtaining processing in a feature obtaining unit according to the second embodiment.

FIGS. 12A to 12C are diagrams for explaining an example of obtaining processing in a position obtaining unit according to the second embodiment.

FIG. 13 is a diagram for explaining spatial resolution estimation processing in a setting unit according to the second embodiment.

FIG. 14 is a diagram for explaining setting processing in the setting unit according to the second embodiment.

FIGS. 15A and 15B are diagrams for explaining an example of setting processing in a setting unit according to Modification 1 of the second embodiment.

### DESCRIPTION OF THE EMBODIMENTS

The present disclosure has been made to solve the above-mentioned problems that the present inventor have found, and provides a technique for appropriately setting parameters in a learning model configured to represent spatial information.

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

In a first embodiment, an aspect is described in which parameters in a learning model are set based on an image feature that are obtained from each of captured images obtained by image-capturing an object from multiple viewpoints and a position of the object. Specifically, in the aspect to be described, a spatial frequency contained in each captured image is obtained as an image feature, and the parameters concerning spatial information in the learning model are set by using the obtained spatial frequency as the image feature.

### <Logical Constituents of Image Processing Apparatus>

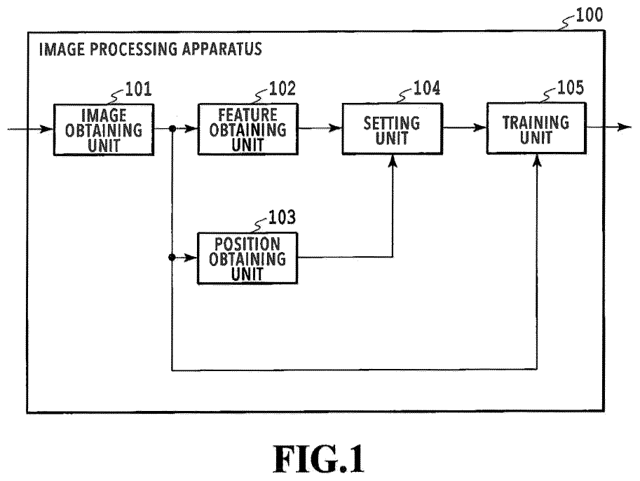

With reference to FIGS. 1 to 7, an image processing apparatus 100 according to the first embodiment is described. First, logical constituents of the image processing apparatus 100 are described with reference to FIG. 1. FIG. 1 is a block diagram illustrating an example of the logical constituents of the image processing apparatus 100 according to the first embodiment. The image processing apparatus 100 includes, as the logical constituents, an image obtaining unit 101, a feature obtaining unit 102, a position obtaining unit 103, a setting unit 104, and a training unit 105.

The image obtaining unit 101 obtains multiple captured images obtained by image-capturing of at least one object from multiple directions and camera parameters for each of the captured images. The camera parameters mentioned herein are of a file or information in which image-capturing conditions are described. Specifically, the camera parameters at least include information on the position of an image-capturing viewpoint, a viewing direction from the image-capturing viewpoint (hereinafter referred to as the “image-capturing viewpoint direction”), and a focal length. The camera parameters may additionally include information on settings of an image capture apparatus or the like as needed. The feature obtaining unit 102 analyzes the spatial frequencies in each captured image obtained by the image obtaining unit 101, and obtains, as an image feature, the highest frequency among the spatial frequencies contained in the captured image and having signal intensities equal to or greater than a given threshold. The position obtaining unit 103 obtains a positional relationship between the image-capturing viewpoint corresponding to each captured image obtained by the image obtaining unit 101 and a region in which the spatial information is to be estimated.

The setting unit 104 estimates a spatial resolution in a training region necessary to represent the image feature based on the image feature obtained by the feature obtaining unit 102 and the positional relationship obtained by the position obtaining unit 103, and sets parameters in a learning model based on the estimated spatial resolution. The training unit 105 trains the learning model in which the parameters are set by the setting unit 104 based on the multiple captured images obtained by the image obtaining unit 101 and the camera parameters for each of the captured images, thereby estimating the spatial information. The learned spatial information is represented by the parameters in the learned model obtained as a result of the training.

### <Hardware Configuration of Image Processing Apparatus>

Processes of the units included as the logical constituents in the image processing apparatus 100 are performed by hardware such as a central processor unit (CPU) built in the image processing apparatus 100. The processes of the units included as the logical constituents in the image processing apparatus 100 may be performed by software using the CPU or a graphics processor unit (GPU) and a memory built in the image processing apparatus 100.

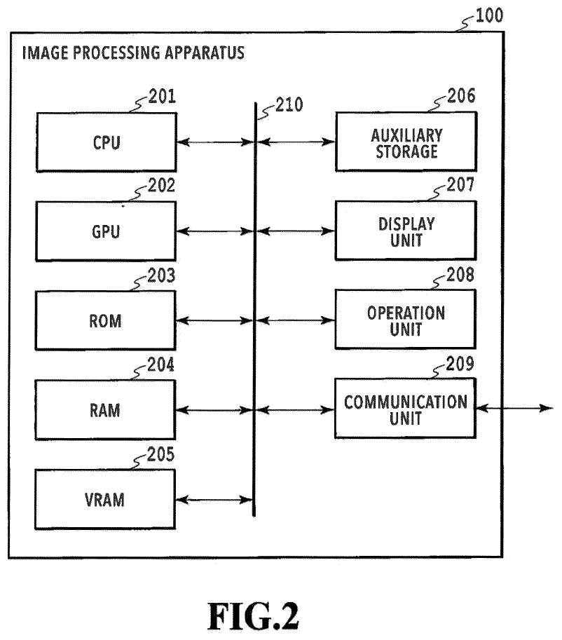

With reference to FIG. 2, a hardware configuration of the image processing apparatus 100 is described in a case where the units included as the logical configurations in the image processing apparatus 100 are implemented through execution of software. FIG. 2 is a block diagram illustrating an example of the hardware configuration of the image processing apparatus 100 according to the first embodiment. The image processing apparatus 100 is composed of a computer. As illustrated in FIG. 2 as an example, the computer includes a CPU 201, a GPU 202, a ROM 203, a RAM 204, a VRAM 205, an auxiliary storage 206, a display unit 207, an operation unit 208, a communication unit 209, and a bus 210.

The CPU 201 controls the computer by using a program and data stored in the ROM 203 or the RAM 204, thereby causing the computer to implement the processes of the units included as the logical constituents in the image processing apparatus 100 illustrated in FIG. 1. The CPU 201 may implement the processes of the units included as the logical constituents in the image processing apparatus 100 in collaboration with the GPU 202 and the VRAM 205. Instead, the image processing apparatus 100 may include one or more pieces of dedicated processing hardware different from the CPU 201 and the dedicated processing hardware may execute at least part of the processes to be executed by the CPU 201. Examples of the dedicated processing hardware include an application specific integrated circuit (ASIC), a field programmable gate array (FPGA), a digital signal processor (DSP), and so on.

The ROM 203 stores programs and so on that will not need to be changed. The RAM 204 temporarily stores programs or data supplied from the auxiliary storage 206 or data and the like supplied from an outside via the communication unit 209. The VRAM 205 temporarily stores data and the like supplied from the ROM 203, the RAM 204, or the auxiliary storage 206. The data stored in the VRAM 205 is used in processing by the GPU 202. The auxiliary storage 206 is composed of, for example, a hard disk drive or the like, and stores various kinds of data such as image data or audio data. The display unit 207 is composed of a liquid crystal display, an LED, or the like, and displays a graphical user interface (GUI) or the like for a user to operate the image processing apparatus 100 or to view a processing status or a processing result of the image processing apparatus 100. The operation unit 208 is composed of a keyboard, a mouse, a touch panel, or the like, receives user's operations, and inputs various instructions according to the operations to the CPU 201. The CPU 201 also operates as a display control unit to control the display unit 207 and an operation control unit to control the operation unit 208.

The communication unit 209 is used for communication of the image processing apparatus 100 with an external apparatus. For example, in a case where the image processing apparatus 100 is connected to the external apparatus by wire, a communication cable is connected to the communication unit 209. In a case where the image processing apparatus 100 has a function to perform wireless communication with the external apparatus, the communication unit 209 has an antenna. The bus 210 connects the units included as the hardware constituents in the image processing apparatus 100 to each other for information transmission. Although the first embodiment is described assuming that the display unit 207 and the operation unit 208 are built in the image processing apparatus 100, at least one of the display unit 207 and the operation unit 208 may be provided as a separate apparatus outside the image processing apparatus 100.

### <Operations of Image Processing Apparatus>

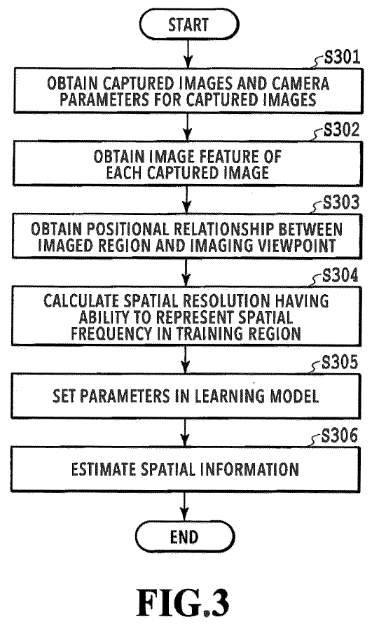

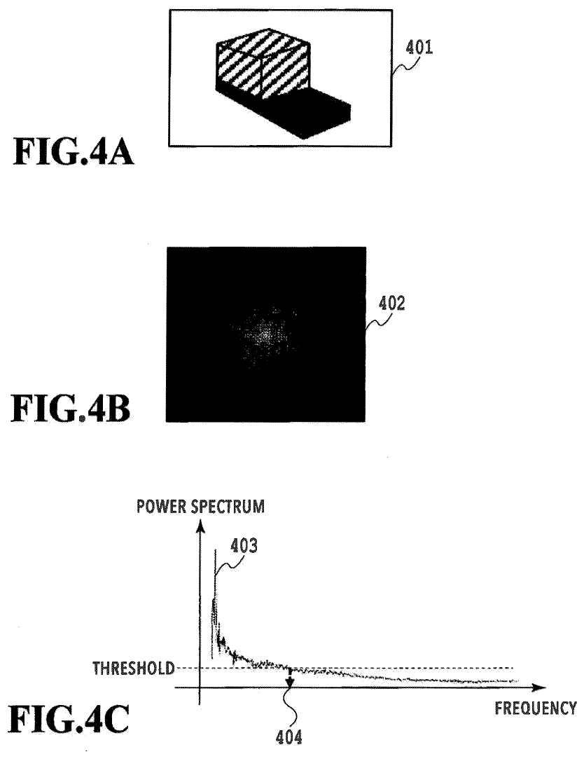

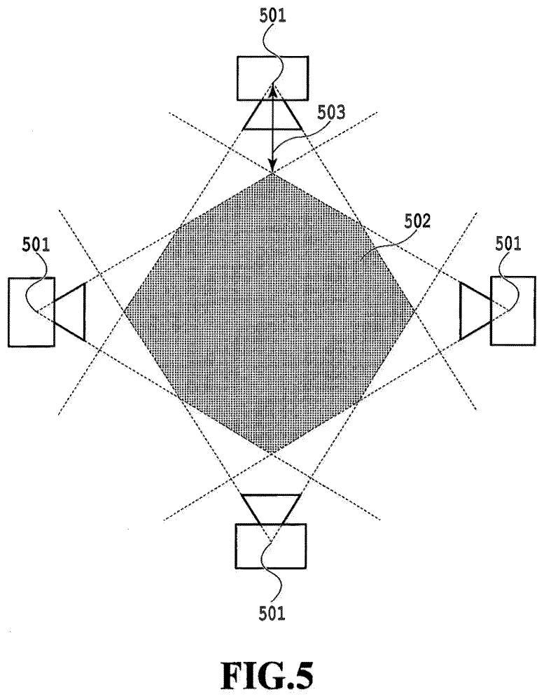

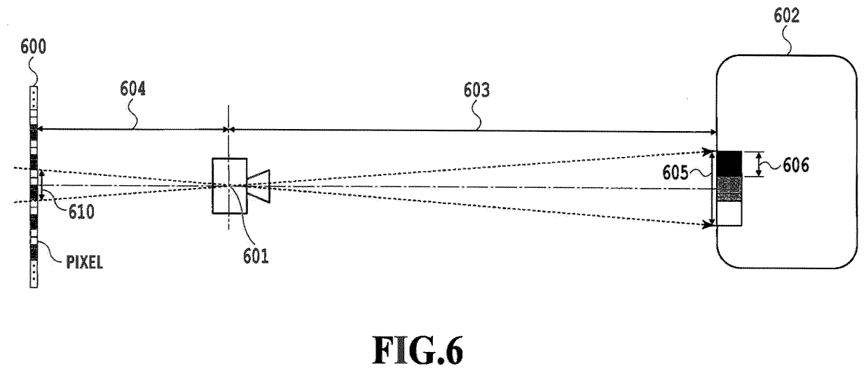

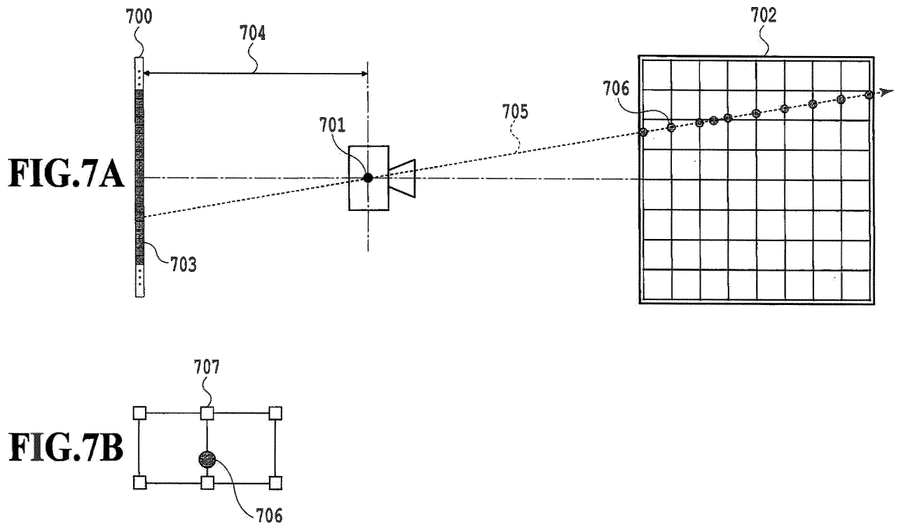

With reference to FIGS. 3 to 7, operations of the image processing apparatus 100 are described. FIG. 3 is a flowchart presenting an example of a processing flow in the image processing apparatus 100 according to the first embodiment. FIGS. 4A to 4C are diagrams for explaining an example of image feature obtaining processing in the feature obtaining unit 102 according to the first embodiment. FIG. 5 is a diagram for explaining an example of processing in the position obtaining unit 103 according to the first embodiment for obtaining a positional relationship between an image-capturing viewpoint corresponding to each captured image and a region in which spatial information is to be estimated. FIG. 6 is a diagram for explaining an example of spatial resolution estimation processing in the setting unit 104 according to the first embodiment. FIGS. 7A and 7B are diagrams for explaining an example of volume rendering processing in the training unit 105 according to the first embodiment. The processing in the flowchart presented in FIG. 3 is implemented by the CPU 201 loading a program stored in the ROM 203 or the like to the RAM 204 and executing the loaded program. In the following description, sign “S” means a step.

First, in S301, the image obtaining unit 101 obtains multiple captured images obtained by image-capturing of at least one object from multiple directions, and camera parameters for each of the captured images. The following description is given assuming that the captured images obtained by the image obtaining unit 101 are RGB images, but the captured images may be another type of images such as monochrome images, monochrome images with transparency, or RGB images with transparency.

Next, in S302, the feature obtaining unit 102 analyzes the spatial frequencies in each of the captured images obtained in S301 to obtain an image feature of that captured image. Using FIGS. 4A to 4C, description is given of an example of obtaining an image feature in the feature obtaining unit 102. FIG. 4A illustrates an example of a captured image 401. First, the feature obtaining unit 102 performs a two-dimensional discrete Fourier transform on the captured image 401. FIG. 4B illustrates an example of a spatial frequency domain image 402 obtained as a result of the two-dimensional discrete Fourier transform on the captured image 401. Subsequently, the feature obtaining unit 102 adds up the signal intensities in each of the same frequency bands in the spatial frequency domain image 402. FIG. 4C illustrates an example of a power spectrum 403 obtained as a result of the addition of the signal intensities.

Next, the feature obtaining unit 102 performs threshold processing on the power spectrum 403 to obtain, as an image feature 404, the highest spatial frequency among the spatial frequencies having the signal intensities equal to or greater than a threshold. In the case where the captured image is an RGB image, the feature obtaining unit 102 obtains, for example, a special frequency for each of the colors in the RGB image, and obtains the image feature based on the total power spectrum obtained by adding up the power spectra for the respective colors. In this case, the feature obtaining unit 102 may obtain the image feature by, for example, analyzing a luminance image obtained by extracting luminance information from the RGB image.

After S302, in S303, the position obtaining unit 103 estimates an image-capturing region where the angles of view from the respective image-capturing viewpoints (hereinafter referred to as the “image-capturing ranges”) overlap each other based on the camera parameters obtained in S301, and obtains as position information a positional relationship between the estimated image-capturing region and each of the image-capturing viewpoints. Using FIG. 5, description is given of an example of obtaining the positional relationship in the position obtaining unit 103. First, the position obtaining unit 103 estimates a region where the image-capturing ranges from all image-capturing viewpoints 501 overlapping each other and sets the estimated region as an image-capturing region 502. Next, the position obtaining unit 103 obtains a distance 503 from each image-capturing viewpoint 501 to the image-capturing region as information indicating the positional relationship between the image-capturing region and the image-capturing viewpoint.

Subsequently, in S304, the setting unit 104 calculates a spatial resolution having an ability to represent the spatial frequency treated as the image feature in the training region obtained in S302. Using FIG. 6, description is given of an example of calculating the spatial resolution in the setting unit 104. First, based on the number of pixels corresponding to the length of one wavelength of the spatial frequency treated as the image feature 404 obtained in S302, the setting unit 104 calculates a length on a sensor 600 covering the above number of pixels. Here, the sensor 600 is used in the image-capturing from the image-capturing viewpoint 601. In the following description, the length on the sensor 600 covering the number of pixels will be referred to as the “sensor size 610”.

Subsequently, the setting unit 104 sets the image-capturing region 502 estimated in S303 as a training region 602. Next, the setting unit 104 calculates a width in the training region 602 equivalent to one wavelength of the spatial frequency treated as the image feature, based on a distance 603 from an image-capturing viewpoint 601 to the training region 602 and a focal length 604 of an optical system of an image capture apparatus located at the image-capturing viewpoint 601. In other words, the setting unit 104 calculates a width of a projection of the sensor size 610 projected on the training region 602 (hereinafter referred to as the “projection width 605”). Subsequently, based on the projection width 605 corresponding to each of the image-capturing viewpoints 501, the setting unit 104 calculates a spatial resolution 606 having an ability to represent the spatial frequency treated as the image feature in the training region. The setting unit 104 calculates such spatial resolutions 606 for all of the image-capturing viewpoints 501. For example, in a case where a pinhole model is considered as an image capture system, the projection width 605 may be calculated by using Equation (1)

$$s = {s}^{′} / f\_img \qquad Equation ( 2 )$$

In Equation (1), L denotes the projection width 605, s denotes the sensor size 610 corresponding to one wavelength of the spatial frequency obtained as the image feature, d denotes the distance 503 (distance 603) from the image-capturing viewpoint 501 (image-capturing viewpoint 601) to the image-capturing region 502 (training region 602), and f denotes the focal length 604 of the optical system such as a lens included in the image capture apparatus located at the image-capturing viewpoint 501 (image-capturing viewpoint 601). Here, the sensor size 610 may be calculated by using Equation (2). In Equation (2), s denotes the sensor size 610, s′ denotes the sensor size per pixel, and f_img denotes a spatial frequency treated as the image feature.

$$L = s \cdot d / f \qquad Equation ( 1 )$$

Here, in order to sample a signal with a wavelength L so that the signal may be restored, it is necessary to sample the signal at intervals smaller than L/2 according to the sampling theorem. For this reason, in FIG. 6, the spatial resolution 606 is presented as L/3 as an example. In this case, Equation (3) holds for a spatial resolution r. In Equation (3), n is a value larger than 2.

$$r = L / n = s \cdot d / f \cdot n \qquad Equation ( 3 )$$

After S304, in S305, the setting unit 104 sets the parameters in the learning model based on the spatial resolution having the greatest value (hereinafter referred to as “highest resolution”) among the spatial resolutions 606 for all the image-capturing viewpoints 601 (image-capturing viewpoints 501) calculated in S304. Specifically, the setting unit 104 sets the parameters in the learning model in which color information and density information are held in a grid form, so that the size of each grid in the learning model is equal to or smaller than the highest resolution. As a result, in the learning model, it may be possible to set parameters in a number equal to or larger than the spatial information parameter number that satisfies the sampling theorem for the captured images.

Next, in S306, the training unit 105 trains the learning model in which the parameters are set in S305 by using the captured images and the camera parameters obtained in S301, thereby estimating the spatial information. The learned model obtained as a result of this training is output to, for example, an external apparatus via the communication unit 209. The learning model is trained so that the learning model may estimate a color and a density relevant to a case where a certain position (x, y, z) in a three-dimensional space and a direction (θ, φ) from an image-capturing viewpoint to that position are specified.

Specifically, the training of the learning model is roughly classified into the following four steps. The first step is a step of determining a process target pixel and multiple sample points in the training region on a ray based on the process target pixel and an image-capturing viewpoint. The second step is a step of calculating a piece of density information and a piece of color information at each of the sample points determined in the first step. The third step is a step of estimating a color value (pixel value) of a pixel corresponding to the process target pixel by adding up the pieces of the density information and the pieces of the color information calculated in the second step. The fourth step is a step of updating the parameters in the learning model based on an error between the color value (pixel value) estimated in the third step and the color value (pixel value) of the process target pixel.

For example, in the first step, the training unit 105 determines, as a sample point, a point at which a ray traveling from the position of the image-capturing viewpoint 501 to each pixel in a captured image obtained by image-capturing from the image-capturing viewpoint 501 intersects with each of grid lines set by the setting unit 104 in the training region. Using FIG. 7A, description is given of an example in which the training unit 105 determines the sample points. First, the training unit 105 sets, as a sample point 706, a point at which a ray 705 corresponding to a certain pixel in a captured image 700 obtained by image-capturing from a certain image-capturing viewpoint 701 intersects with each grid line in a training region 702. In FIG. 7A, a distance 704 is the focal length of the optical system such as the lens included in the image capture apparatus located at the image-capturing viewpoint 701.

Next, in the second step, the training unit 105 calculates the density information and the color information at the sample point 706 by complementing these kinds of information with the density information and the color information at surrounding lattice points of the grid line including the sample point 706. Using FIG. 7B, description is given of an example in which the training unit 105 calculates the density information and the color information at the sample point 706. The learning model holds the density information and the color information at the coordinates of each lattice point 707 on the grid line, the color information depending on a direction (θ, φ) from the image-capturing viewpoint. The density information and the color information at the sample point 706 are calculated by being complemented based on the density information and the color information at the multiple lattice points 707 located around the sample point 706.

Subsequently, in the third step, the training unit 105 adds up the pieces of the color information and the pieces of the density information at the respective sample points set on the ray 705 traveling from the position of the image-capturing viewpoint 701 to the pixel 703 in the captured image 700 in the order starting from the pixel closest to the image-capturing viewpoint 701. As a result of this addition, the value at the pixel 703 (pixel value) for each captured image 700 is estimated. This pixel value estimation method is generally called the volume rendering method. Specifically, the pixel value obtained in the volume rendering method based a ray r is calculated by using the following Equations (4) to (6).

$$\begin{matrix}\overline{C} ( r ) = {\sum }_{i = 1}^{N} {T}_{i} {α}_{i} {c}_{i} & Equation ( 4 ) \\ {T}_{i} = exp ( - {\sum }_{j = 1}^{i - 1} {σ}_{j} {δ}_{j} ) & Equation ( 5 ) \\ {α}_{i} = ( 1 - exp ( {σ}_{i} {δ}_{i} ) ) & Equation ( 6 )\end{matrix}$$

Here, r denotes a ray, Ĉ(r) denotes a color value (pixel value) estimated by the volume rendering based on the ray r, i and j denote sample points, σᵢ and cᵢ respectively represent the density and the color value at a sample point i, δᵢ denotes a distance from the sample point i to the sample point i+1, Tᵢ denotes a total transmittance up to the sample point i, and αᵢ represents an opacity from the sample point i to the sample point i+1.

Next, in the fourth step, the training unit 105 trains the learning model by updating the parameters in the learning model so that the difference (error) between an image generated by the volume rendering and the captured image as the correct data is reduced. The training unit 105 iterates the first to fourth steps on each of the captured images until a training termination condition is satisfied. The training termination condition mentioned herein is, for example, a condition where the number of updates of the learning model reaches a predetermined number of times or the like. The training termination condition is not limited to the condition based on the number of updates of the learning model, and may be a condition where a training period of time reaches a predetermined period, a condition where an error or a decrease rate in errors falls to a predetermined threshold or below, or the like.

As described above, in the present embodiment, the image processing apparatus 100 is configured to change the spatial resolution in a learning model depending on an image feature of a captured image in the estimation of the spatial information. The image processing apparatus 100 thus configured is capable of setting the parameters in the learning model to represent the spatial information, according to a high-frequency component contained in the captured image. As a result, the spatial information with high accuracy may be estimated while the amount of calculation required to train the learning model is kept appropriate.

In the present embodiment, the learning model to be processed by the setting unit 104 and the training unit 105 is described as a model in which the color information and the density information are held in the grid form. However, a type of a learning model is not limited to a format in which information is held in a three-dimensional grid form. For example, a learning model to be processed may be a deep neural network (DNN) that receives position information and information on a rendering direction as inputs and outputs the color information and the density information. In the case where the DNN is used as the learning model, the spatial information parameter number in the DNN per volume is changed based on the spatial resolution calculated in S305. Such a change in the spatial information parameter number may make it possible to automatically set a learning model in a model size capable of learning a representation according to a high frequency component contained in a captured image. Instead, for example, a learning model to be processed may be in the format of a tetrahedron group in which a space containing a target object is divided into multiple tetrahedrons, with color information and density information being held at each vertex of each tetrahedron. In the case where the format of the tetrahedron group is used as the learning model, the number of tetrahedrons per volume may be increased or decreased using tessellation or tetrahedral integration based on the spatial resolution calculated in S305. This may also make it possible to automatically set a learning model in the format of tetrahedron group in a model size capable of learning a representation according to a high frequency component contained in a captured image.

Alternatively, a learning model to be processed may be, for example, 3D Gaussian splatting (3DGS), which represents a three-dimensional scene by three-dimensionally distributing data points each having information on spatial extent, color, and density. In the case where the 3DGS is used as the learning model, the number of data points distributed per volume is changed based on the spatial resolution calculated in S305. Such a change in the number of data points distributed per volume may make it possible to automatically set a learning model in a model size capable of learning a more complicated representation according to a high frequency component contained in a captured image.

Although the present embodiment is described in which the color information and the density information are trained by the training unit 105, subjects to be trained by the training unit 105 are not limited to these. For example, the training unit 105 may be configured to train information at a certain position concerning a density, a signed distance from the object surface, a color, different colors among directions, or the like, information on a combination of these, or the like.

### [Modification 1 of First Embodiment]

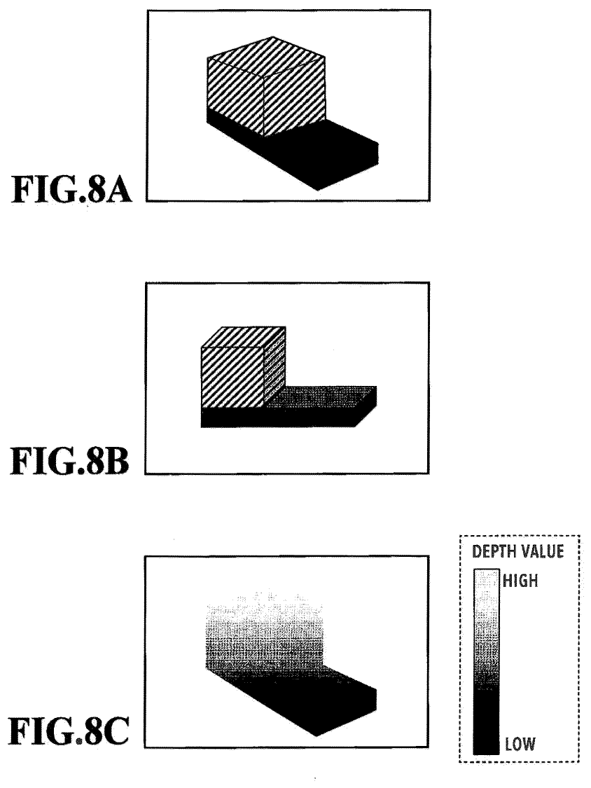

The position obtaining unit 103 according to the first embodiment sets, as the training region, a region (image-capturing region) in which the image-capturing ranges from all the image-capturing viewpoints 501 overlap each other, and obtains, as the position information, the distances between the image-capturing viewpoints and the training region. In addition, the setting unit 104 sets the parameters in the learning model based on the position information obtained by the position obtaining unit 103. However, the position information obtained by the position obtaining unit 103 is not limited to the information on the distances between the image-capturing viewpoints and the training region. For example, the position obtaining unit 103 may obtain, as the position information, depth information on a depth from each of the image-capturing viewpoints based on the multiple captured images and the camera parameters for each of the captured images obtained by the image obtaining unit 101. In this case, the setting unit 104 sets the parameters in the learning model based on the depth information obtained by the position obtaining unit 103. The modification as described above is explained by using FIGS. 8A to 8C.

FIGS. 8A to 8C are diagrams for explaining an example of position information obtaining processing in the position obtaining unit 103 according to Modification 1 of the first embodiment. FIGS. 8A and 8B illustrate an example of captured images obtained by image-capturing from different image-capturing viewpoints. First, the position obtaining unit 103 performs a stereo matching between the captured images illustrated in FIGS. 8A and 8B, thereby calculating distances from each of the image-capturing viewpoints to an object. Subsequently, the position obtaining unit 103 generates the depth information based on the distances obtained by the calculation, and obtains the generated depth information as the position information. FIG. 8C illustrates an example of a depth image expressed by the depth information obtained by the stereo matching between the captured images illustrated in FIGS. 8A and 8B.

In the above description, the depth information is obtained by the position obtaining unit 103 calculating the distances from each of the image-capturing viewpoints to the object based on the captured images and the camera parameters obtained by the image obtaining unit 101. However, the method of obtaining the depth information is not limited to this. For example, the position obtaining unit 103 may obtain the depth information by obtaining data of a depth image calculated and output by an external apparatus outside the image processing apparatus 100 via the communication unit 209.

The setting unit 104 estimates a spatial resolution in the training region necessary to represent the image feature based on the distances from the image-capturing viewpoints to the object, which are indicated in the depth information obtained as the position information by the position obtaining unit 103, and sets the parameters in the learning model based on the spatial resolution.

In the case where an object is present in the image-capturing region 502, a depth value equivalent to the distance from the image-capturing viewpoint 501 to the object is larger than the value of the distance from the image-capturing viewpoint 501 to the image-capturing region 502. For this reason, in the case where the spatial resolution r is calculated by using Equation (3), the value of the spatial resolution r calculated by using the depth information is lower than the value of the spatial resolution r according to the first embodiment. Accordingly, the number of points at which the ray intersects with the grid lines is decreased in the training by the training unit 105 and the amount of calculation required for the training may be decreased.

The training unit 105 may set an initial value of each parameter in the learning model based on the depth information as the position information obtained by the position obtaining unit 103. For example, the training unit 105 may start training the learning model from a state close to convergence of the training by setting a high initial value to the density information at coordinates corresponding to an object surface that may be estimated based on the depth value indicated by the obtained depth information.

In the foregoing description, the depth information calculated through the stereo matching between two captured images is used as the position information. However, the method of obtaining the depth information is not limited to this. For example, the position obtaining unit 103 may use three or more captured images obtained by image-capturing from three or more image-capturing viewpoints and calculate the distances from each of the image-capturing viewpoints to the object in a multi-view stereo method. Moreover, for example, the position obtaining unit 103 may estimate the distances from each of the image-capturing viewpoints to the object by using a learned model obtained as a result of deep learning or the like, instead of the stereo matching using two captured images or the multi-view stereo method using three or more captured images.

### [Modification 2 of First Embodiment]

The feature obtaining unit 102 according to the first embodiment analyzes the spatial frequencies in each captured image, and obtains, as the image feature, the highest spatial frequency among the spatial frequencies having components greater than the threshold. However, the method of obtaining the image feature in the feature obtaining unit 102 is not limited to this. For example, the feature obtaining unit 102 may set the parameters in the learning model based on a shape of an object in a captured image. Specifically, for example, the feature obtaining unit 102 first extracts a region containing a representation of an object (referred to as a “foreground region” below) and a region related to the background (referred to as a “background region” below) from each captured image. Subsequently, the feature obtaining unit 102 estimates a shape of the object in each captured image based on the foreground region extracted from the captured image. Next, the feature obtaining unit 102 sets the parameters in the learning model based on information on the estimated shape of the object in the captured image.

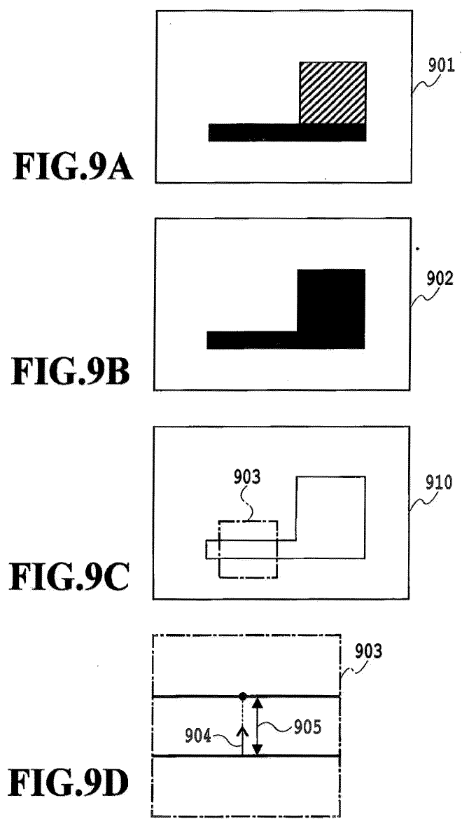

FIGS. 9A to 9D are diagrams for explaining an example of image feature obtaining processing in the feature obtaining unit 102 according to Modification 2 of the first embodiment. FIG. 9A illustrates an example of a captured image 901. The feature obtaining unit 102 extracts a region (foreground region) containing a representation of an object in the captured image 901, and generates a silhouette image representing the foreground region. The method of extracting the foreground region may be a method based on a difference from a background image having been captured in advance, a method based on chroma key processing using a green screen, or a method using a learned model having learned to separate a foreground region from a background region in an input image. FIG. 9B illustrates an example of a silhouette image 902. In the silhouette image 902 in FIG. 9B, a region representing a foreground region in the captured image 901 is expressed in black color and a region representing a region other than the foreground region (background region) is expressed in white color.

Next, the feature obtaining unit 102 generates an outline image representing an outline of the object by extracting an outline of the region representing the foreground region in the silhouette image 902. FIG. 9C illustrates an example of an outline image 910. FIG. 9D is an enlarged view of a partial region 903 in the outline image 910. The feature obtaining unit 102 obtains a normal line 904 at each of pixels constituting the outline of the object in the outline image 910, the normal line 904 pointing inward from the outline (referred to as an “inward normal line” below). Then, the feature obtaining unit 102 calculates, as an object width 905, the minimum value of a distance from each of the pixels constituting the outline to another pixel constituting the outline, which exists in the direction of the inward normal line 904 at the former pixel constituting the outline. Next, the feature obtaining unit 102 obtains, as the image feature of the captured image 901, the smallest object width 905 among the object widths 905 calculated for all the pixels constituting the outline.

The setting unit 104 calculates a sensor size based on the number of pixels corresponding to the object width 905 obtained as the image feature by the feature obtaining unit 102. The setting unit 104 calculates the spatial resolution in the training region based on the calculated sensor size by using Equation (3) or the like. Then, the setting unit 104 sets the parameters in the learning model based on the spatial resolution in the training region.

The image processing apparatus 100 thus configured may set the parameters in the learning model having an ability to reproduce the foreground region in the captured image 901.

### Second Embodiment

The image processing apparatus 100 according to the first embodiment obtains the image feature from each captured image and sets the same spatial information parameter number of parameters in the entire training region. However, unless an object has a uniform texture or equal shape in views from all image-capturing viewpoints, the spatial information parameter number in a learning model suitable for representing the spatial information for the object varies among portions of the object. Therefore, the second embodiment is described about an aspect in which parameters in a spatial information parameter number suitable for each of partial regions in a training region are set in a learning model.

### <Configuration of Image Processing Apparatus>

An image processing apparatus according to the second embodiment includes, as logical constituents, an image obtaining unit, a feature obtaining unit, a position obtaining unit, a setting unit, and a training unit. Unless otherwise specified, the following description is given by referring the image processing apparatus according to the second embodiment to as the “image processing apparatus 100”. In addition, unless otherwise specified, the following description is given by referring the units included as the logical constituents in the image processing apparatus 100 to as the image obtaining unit 101, the feature obtaining unit 102, the position obtaining unit 103, the setting unit 104, and the training unit 105. Processes of the units included as the logical constituents in the image processing apparatus 100 are performed by hardware such as a CPU built in the image processing apparatus 100. The processes of the units included as the logical constituents in the image processing apparatus 100 may be performed by software using the CPU or a GPU and a memory built in the image processing apparatus 100. Instead, the image processing apparatus 100 may include one or more pieces of dedicated processing hardware different from the CPU 201 and the dedicated processing hardware may execute at least part of the processes to be executed by the CPU 201.

The processes in the image obtaining unit 101 are the same as the processes in the image obtaining unit 101 according to the first embodiment, and therefore the description thereof is omitted herein. The feature obtaining unit 102 divides each captured image into multiple small images and obtains an image feature for each of the small images. The method of obtaining an image feature for each of the small images in the feature obtaining unit 102 is the same as the method of obtaining an image feature for a captured image in the feature obtaining unit 102 according to the first embodiment, and therefore the description thereof is omitted herein.

The position obtaining unit 103 obtains, as the position information for each of the small images into which the captured image is divided by the feature obtaining unit 102, the distance from the image-capturing viewpoint to a portion of an object contained as a representation in the small image. Specifically, first, the position obtaining unit 103 estimates a three-dimensional shape of the object by a visual hull method or the like using the multiple captured images and the camera parameters for each of the captured images, which are obtained by the image obtaining unit 101. Next, using the estimated three-dimensional shape, the position obtaining unit 103 obtains, as the position information for each of the small images, the distance from the image-capturing viewpoint to the portion of the object contained as the representation in the small image. Here, the position obtaining unit 103 may obtain the position information for each of the small images by obtaining the depth value from the depth image by use of the same method as in Modification 1 of the first embodiment.

The setting unit 104 sets multiple small training regions in the training region and sets parameters in the learning model for each of the small training regions based on the image feather for the corresponding one of the small images obtained by the feature obtaining unit 102. Specifically, first, based on the image feature of each of the small images obtained by the feature obtaining unit 102 and the position information for the above small image obtained by the position obtaining unit 103, the setting unit 104 calculates a spatial resolution around a point where the ray corresponding to each of pixels in the above small image intersects with the object. Next, based on the estimated spatial resolution, the setting unit 104 sets the parameters in the learning model for each of the small training regions set in the training region. The training unit 105 estimates the spatial information for the entire training region by training the learning model for each of the small training regions set by the setting unit 104.

### <Operations of Image Processing Apparatus>

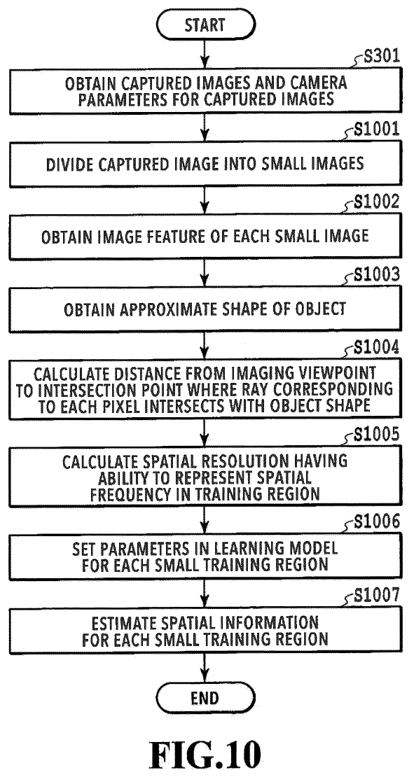

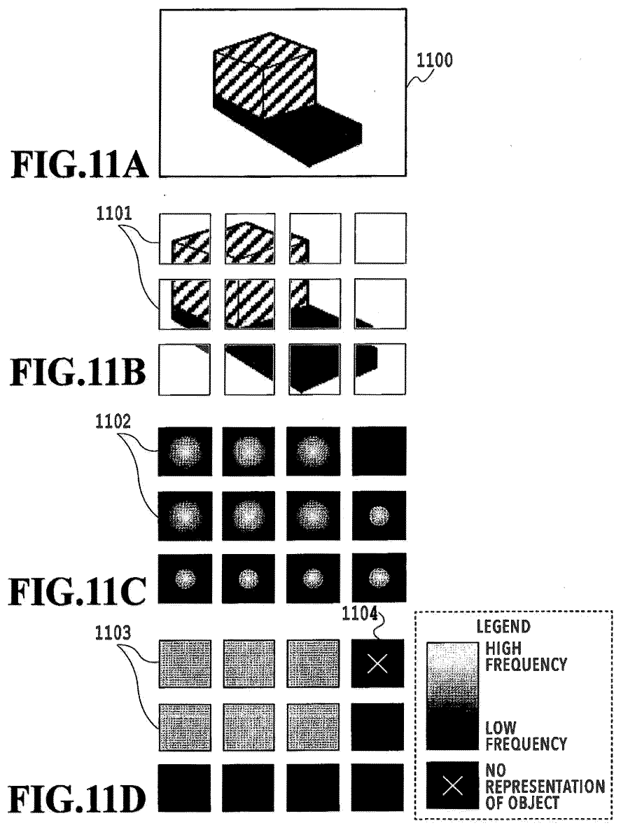

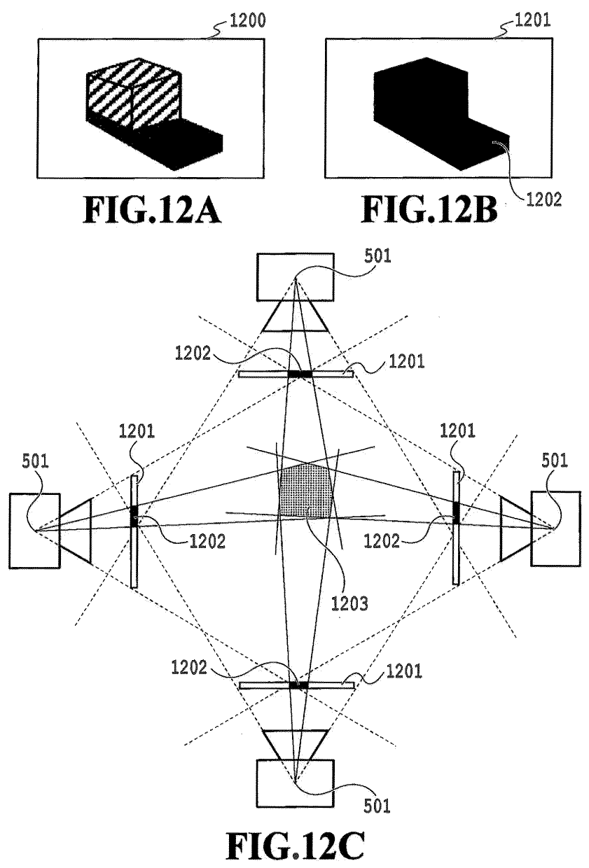

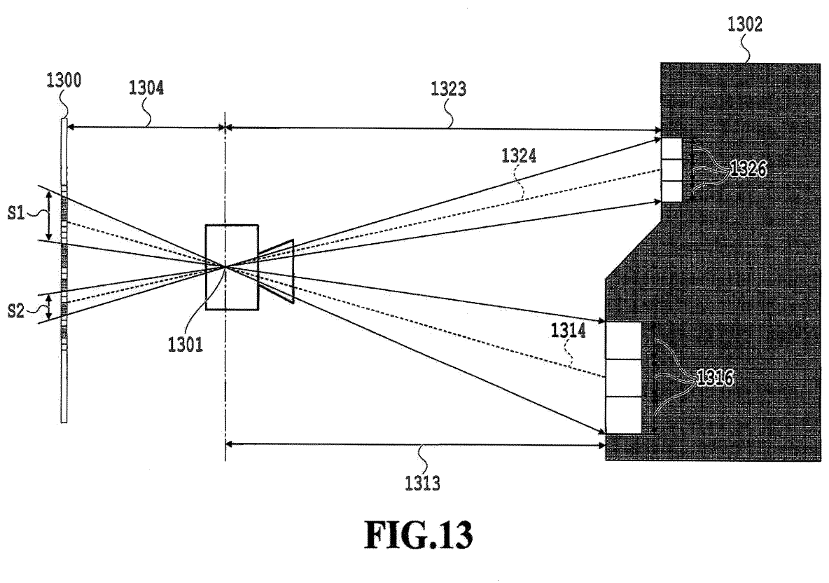

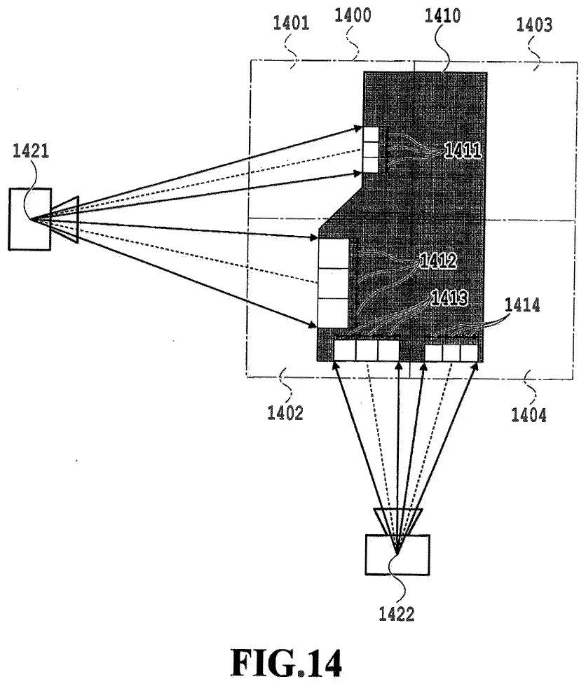

With reference to FIGS. 10 to 14, operations of the image processing apparatus 100 are described. FIG. 10 is a flowchart presenting an example of a processing flow in the image processing apparatus 100 according to the second embodiment. FIGS. 11A to 11D are diagrams for explaining an example of image feature obtaining processing in the feature obtaining unit 102 according to the second embodiment. FIGS. 12A to 12C are diagrams for explaining an example of position information obtaining processing in the position obtaining unit 103 according to the second embodiment. FIG. 13 is a diagram for explaining an example of spatial resolution estimation processing for small images in the setting unit 104 according to the second embodiment. FIG. 14 is a diagram for explaining an example of learning model parameter setting processing in the setting unit 104 according to the second embodiment. First, the image processing apparatus 100 executes the process in S301 in FIG. 3.

Next, in S1001, the feature obtaining unit 102 generates multiple small images by dividing each of the captured images obtained in S301. FIG. 11A illustrates an example of a captured image 1100. The feature obtaining unit 102 generates multiple small images by dividing the captured image 1100. FIG. 11B illustrates an example of small images 1101 generated by dividing the captured image 1100. Although the present embodiment is described about an example illustrated in FIG. 11B in which the captured image 1100 is divided to generate the small images 1101 which do not overlap each other in any region, the method of generating small images is not limited to this. For example, the feature obtaining unit 102 may generate small images such that adjacent small images overlap each other in some parts of the image region in the captured image 1100.

Next, in S1002, in the same method as in the first embodiment, the feature obtaining unit 102 analyzes each of the small images 1101 to obtain power spectra of spatial frequencies, and then obtains, as an image feature for each of the small images 1101, the highest spatial frequency among the spatial frequencies each having a power spectrum equal to or greater than a threshold. FIG. 11C illustrates an example of spatial frequency domain images 1102 for the respective small images 1101 obtained as a result of a two-dimensional Fourier transform on the small images 1101. FIG. 11D illustrates an example of image features 1103 and 1104 for the respective small images 1101. Here, to a small image not containing any representation of the object as in the image feature 1104, a label or value indicating the absence of a representation may be allocated.

Next, in S1003, the position obtaining unit 103 generates a silhouette image by extracting a region (foreground region) containing the representation of the object in each of the captured images obtained in S301 and obtains an approximate shape of the object based on the generated silhouette image. Specifically, for example, the position obtaining unit 103 obtains the approximate shape by the visual hull method or the like. FIG. 12A illustrates an example of a captured image 1200. The position obtaining unit 103 generates a silhouette image for each of the captured images by extracting the foreground region from that captured image. FIG. 12B illustrates an example of a silhouette image 1201 presenting the foreground region, the silhouette image 1201 generated by extracting the foreground region from the captured image 1200.

Subsequently, the position obtaining unit 103 obtains the approximate shape of the object by using the silhouette images for the respective captured images and the camera parameters for each of the captured images. FIG. 12C is a diagram for explaining an example of object approximate shape obtaining processing. The position obtaining unit 103 obtains an approximate shape 1203 of the object by, for example, the visual hull method. Specifically, using the camera parameters for the captured image for each of the image-capturing viewpoints 501, the position obtaining unit 103 projects the background region in the silhouette image 1201 corresponding to the above image-capturing viewpoint 501 to a three-dimensional space, thereby obtaining the approximate shape 1203 of the object. The position obtaining unit 103 may obtain the approximate shape 1203 of the object by projecting the foreground regions 1202 in the silhouette images 1201 to the three-dimensional space.

More specifically, for example, the position obtaining unit 103 projects, to a three-dimensional space, a ray corresponding to each of pixels (hereinafter referred to as “background pixels”) contained in the background region in the silhouette image 1201 corresponding to each of the image-capturing viewpoints 501. The position obtaining unit 103 obtains the approximate shape 1203 of the object by estimating, as a region containing the object, a three-dimensional space which does not intersect with any of the rays corresponding to the respective background pixels. In the silhouette images 1201 in FIGS. 12B and 12C, black regions indicate the foreground regions 1202 and white regions indicate the background regions. FIG. 12C illustrates the cross-sections of the silhouette images 1201. However, in reality, in order to obtain an approximate shape of a three-dimensional object, the approximate shape of the object is estimated by using the entire silhouette images 1201.

In S1004, the position obtaining unit 103 calculates the position of an intersection point at which the ray corresponding to each of pixels (hereinafter referred to as “foreground pixels”) included in the foreground region in each small image intersects with the approximate shape of the object, thereby calculating the distance from the image-capturing viewpoint 501 to the intersection point. Next, in S1005, the setting unit 104 executes the same processing as in the spatial resolution estimation processing in the first embodiment (the process in S304 in FIG. 3) on each small image, thereby calculating the spatial resolution in the small image.

The processes in S1004 and S1005 are described by using FIG. 13. First, the setting unit 104 calculates coordinates of an intersection point at which each of rays 1314 and 1324 corresponding to foreground pixels in a captured image intersects with a surface of an approximate shape 1302 of an object. Subsequently, the setting unit 104 obtains distances 1313 and 1323 from the image-capturing viewpoint 1301 to the intersection points as the position information indicating the positional relationship. In FIG. 13, a distance 1304 is a focal length of an optical system such as a lens included in an image capture apparatus located at the image-capturing viewpoint 1301. In FIGS. 13, S1 and S2 indicate the sensor sizes on a sensor 1300 each equivalent to one wavelength of the corresponding one of image features (spatial frequencies) for the respective two small images. In FIG. 13, the distances 1313 and 1323 indicate the distances from the image-capturing viewpoint 1301 to the approximate shape 1302 of the object for the respective two small images. The setting unit 104 calculates spatial resolutions 1316 and 1326 for the respective two small images by using Equation (3) or the like as in the first embodiment. In the case where the sensor size or the distance to the approximate shape 1302 of the object treated as the image feature is different between small images as illustrated in FIG. 13, the different values are calculated as the spatial resolutions 1316 and 1326.

Here, in a case where the direction of the normal line at an intersection point at which the optical axis of the image capture apparatus located at the image-capturing viewpoint 1301 intersects with the approximate shape 1302 of the object deviates from the direction of the optical axis, the surface of the object is inclined with respect to a plane orthogonal to the optical axis. For this reason, the captured image has a higher spatial frequency than that of the actual texture on the surface of the object. In the case where the spatial resolutions 1316 and 1326 are sufficiently small relative to the distances 1313 and 1323 to the approximate shape 1302 of the object, each of the spatial resolutions may be approximated to a value of the spatial resolution according to the first embodiment multiplied by 1/cos θ, where θ denotes an angle formed between the normal line and the optical axis. In an image of a texture on a surface of an object captured from an oblique angle, a distortion in which the texture has a high spatial resolution may be corrected through such approximation.

Next, in S1006, the setting unit 104 sets multiple small training regions in the training region based on the approximate shape of the object and sets the parameters in the learning model for each of the small training regions based on the spatial resolution calculated in S1005. Using FIG. 14, small learning model setting processing in the setting unit 104 is described. First, the setting unit 104 sets multiple small training regions 1401 to 1404 in a training region 1400 containing an approximate shape 1410 of an object. Hereinafter, an aspect where four small training regions 1401 to 1404 are set in a training region 1400 containing the approximate shape 1410 of the object is described as an example. The number of small training regions set in the training region 1400 may be any number of two or more, such as three or less or five or more. The method of setting small training regions may be a method of setting small training regions in a predetermined size in a training region or a method of setting multiple small training regions by dividing a training region into a predetermined number of small training regions. Instead, the method may be a method of setting small training regions based on a size, shape, or the like of the approximate shape 1203 of the object obtained by the position obtaining unit 103.

Next, the setting unit 104 allocates spatial resolutions 1411 to 1414 calculated based on small images captured from the image-capturing viewpoints 1421 and 1422 to the small training regions 1401 to 1404. Then, for each of the small training regions 1401 to 1404, the setting unit 104 sets parameters in the learning model related to that small training region 1401, 1402, 1403, or 1404 based on the corresponding one of the spatial resolutions 1411 to 1414 thus allocated. Here, two spatial resolutions 1412 and 1413 are allocated to the small training region 1402. In the case where multiple spatial resolutions are allocated to a single small training region as above, the setting unit 104 sets the parameters in the learning model related to the single small training region based on the highest spatial resolution among the multiple spatial resolutions allocated to the single small training region.

Next, in S1007, the training unit 105 trains the learning model related to each of the small training regions 1401 to 1404 for which the parameters are set in S1006, based on each of the captured images and the camera parameters for each of the captured images obtained in S301. As a result of this training, spatial information for each of the small training regions 1401 to 1404 is estimated. In the present embodiment, the learning model has the color information and the density information in a grid form as in the first embodiment. In the training processing by the training unit 105, the same training processing as in the training unit 105 according to the first embodiment is performed on the learning model related to each of the small training regions 1401 to 1404.

According to the image processing apparatus 100 thus configured, parameters suitable to a high-frequency component contained in a captured image may be set in a learning model related to each of multiple small training regions set in a training region containing an approximate shape of an object. As a result, spatial information with high accuracy may be set while the amount of calculation required to train the learning model is kept appropriate.

Although the present embodiment is described about the case where the position obtaining unit 103 obtains the approximate shape of the object by using the visual hull method, the method of obtaining the approximate shape of the object is not limited to the visual hull method. For example, the approximate shape of an object may be estimated by the multi-view stereo method using multiple captured images obtained by image-capturing from multiple image-capturing viewpoints. Instead, for example, in a case where an object is a human-shaped object, the approximate shape of the object may be estimated by bone estimation or pose estimation and deformation of a standard human model using captured images. In addition, in a case where there are multiple objects in a space to be treated as a training region, the feature obtaining unit 102 may generate small images based on the positions of the respective objects. In this case, the setting unit 104 may set a training region or small training regions based on the position of each of the objects. Moreover, the setting unit 104 may set initial values of parameters related to a density in a learning model based on information on an approximate shape of an object obtained by the position obtaining unit 103.

### [Modification 1 of Second Embodiment]

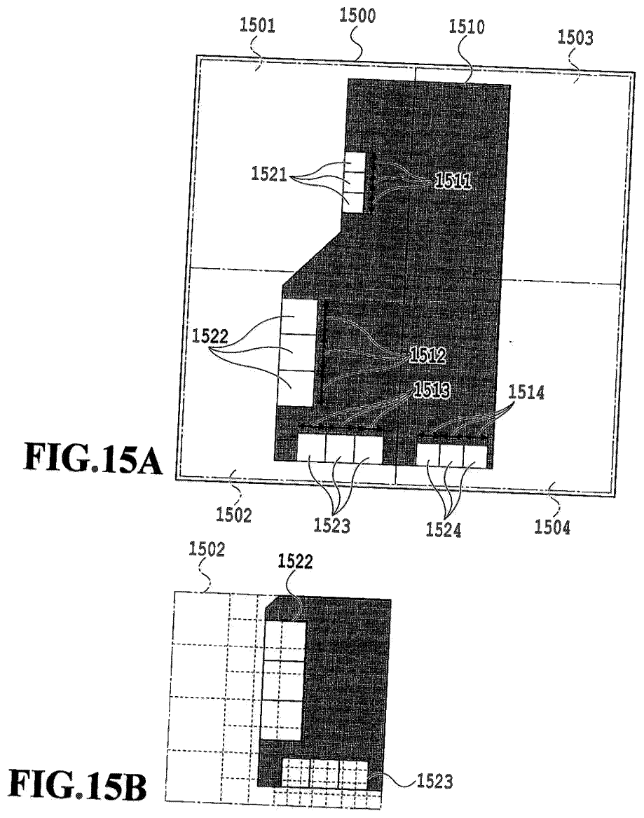

The image processing apparatus 100 according to the second embodiment sets multiple small training regions in a training region and sets the parameters in the learning model for each of the small training regions. However, it may be also possible to recursively partition a training region using an octree or the like, and set the parameters in the learning model for each of the recursively partitioned regions. FIGS. 15A and 15B are diagrams for explaining an example of learning model parameter setting processing with octree space partitioning in the setting unit 104 according to Modification 1 of the second embodiment. Specifically, FIG. 15A illustrates a state where a training region 1500 is partitioned into quarter areas. FIG. 15B illustrates a way to recursively partition the training region 1500 into quarter areas.

As illustrated in FIG. 15B, the setting unit 104 recursively partitions the training region 1500 into quarter areas or the like, and further into smaller areas. Specifically, the setting unit 104 recursively partitions each of four regions 1501 to 1504 into which the training region 1500 is partitioned as illustrated in FIG. 15A into regions smaller than the estimated spatial resolution as illustrated in FIG. 15B. In FIGS. 15A and 15B, a shape 1510 is a three-dimensional shape of an object. The sizes of rectangles 1521 to 1524 represent spatial resolutions 1511 to 1514 of the object. More specifically, for example, as illustrated in FIG. 15B, a training region at and around the surface of the object having the spatial resolution 1512 represented by the rectangle 1522 is partitioned until the size of each partitioned region is equal to or smaller than the size of the rectangle 1522. For example, as illustrated in FIG. 15B, a training region at and around the surface of the object having the spatial resolution 1513 represented by the rectangle 1523 is partitioned until the size of each partitioned region is equal to or smaller than the size of the rectangle 1523.

In the case where parameters in the learning model having color information and density information are set based on information obtained by partitioning in such octrec format, it may be possible to set the learning model having a representation ability that differs among locations in a training space.

### OTHER EMBODIMENTS

In the above-described embodiments, the image processing apparatus 100 is described as including the training unit 105 as the logical constituent. However, the image processing apparatus 100 may not include the training unit 105. In this case, the image processing apparatus 100 outputs the learning model in which the parameters are set by the setting unit 104 to an information processing apparatus including the training unit 105 as a logical constituent, and the latter information processing apparatus trains the learning model. The latter information processing apparatus mentioned herein is composed of one or more server apparatuses, personal computers, or the like, for example.

The image processing apparatus 100 may include a viewpoint obtaining unit and an image generation unit not illustrated in FIG. 1 in addition to the logical constituents illustrated in FIG. 1. The viewpoint obtaining unit and the image generation unit may be implemented, for example, by hardware such as the CPU built in the image processing apparatus 100. Here, the viewpoint obtaining unit is a logical constituent to obtain virtual viewpoint information containing information on the position of a virtual viewpoint and the viewing direction from the virtual viewpoint. The image generation unit is a logical constituent to generate an image (virtual viewpoint image) representing a view from the virtual viewpoint based on the spatial information obtained as a result of training the learning model in the training unit 105 and the virtual viewpoint information obtained by the viewpoint obtaining unit. In this case, the image processing apparatus 100 may output the generated virtual viewpoint image in addition to or in place of the estimated spatial information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it may be possible to appropriately set parameters in a learning model configured to represent spatial information.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-157695, filed Sep. 11, 2024, which is hereby incorporated by reference herein in its entirety.

What is claimed is:

1. An image processing apparatus comprising:
one or more hardware processors; and
one or more memories storing one or more programs configured to be executed by the one or more hardware processors, the one or more programs including instructions for:
obtaining a plurality of images obtained by image-capturing a three-dimensional space containing an object from a plurality of directions;
analyzing the images to obtain an image feature related to each of the images;
obtaining position information indicating a position of the object; and
setting a parameter in a learning model to estimate spatial information related to a training region contained in the three-dimensional space, based on the position information and the image feature.

2. The image processing apparatus according to claim 1, wherein
the one or more programs further include instructions for training the learning model.

3. The image processing apparatus according to claim 1, wherein
the one or more programs further include instructions for setting, in the learning model, the parameter having an ability to represent a high spatial resolution in the training region, in a case where a spatial frequency of the image is high.

4. The image processing apparatus according to claim 1, wherein
the one or more programs further include instructions for setting, in the learning model, the parameter having an ability to represent a high spatial resolution in the training region, in a case where a distance from an image-capturing position to the object or the training region is short.

5. The image processing apparatus according to claim 1, wherein
the one or more programs further include instructions for setting, in the learning model, the parameter having an ability to represent a high spatial resolution in the training region in a case where an angle formed between an optical axis of an image capture apparatus corresponding to the image and a normal line to a surface of the object, the normal line intersecting with the optical axis, is small.

6. The image processing apparatus according to claim 1, wherein
the one or more programs further include instructions for setting, in the learning model, the parameter having an ability to represent the highest spatial resolution among the plurality of spatial resolutions estimated, in a case where a plurality of spatial resolutions related to the training region or the object are estimated based on the image features respectively related to the plurality of images.

7. The image processing apparatus according to claim 1, wherein
the one or more programs further include instructions for setting, in the learning model corresponding to each of a plurality of the training regions for which different parameters are settable or in the learning model in which different parameters are settable in a plurality of partial regions contained in the training region, the parameter based on the spatial resolution estimated for each of the regions or the partial regions for which the different parameters are settable.

8. The image processing apparatus according to claim 1, wherein
the one or more programs further include instructions for obtaining a frequency feature related to a spatial frequency obtained by analyzing the image as the image feature.

9. The image processing apparatus according to claim 1, wherein
the one or more programs further include instructions for obtaining, based on a width of a plurality of pixels constituting a foreground region containing a representation of the object in the image, a minimum value of the width of the foreground region as the image feature.

10. The image processing apparatus according to claim 1, wherein
the one or more programs further include instructions for generating a plurality of small images from each of the images and obtaining the image feature related to the image for each of the small images.

11. The image processing apparatus according to claim 1, wherein
the one or more programs further include instructions for obtaining a depth image indicating distances from the image-capturing position to the object or information on a three-dimensional shape of the object estimated based on the plurality of images, as the position information.

12. The image processing apparatus according to claim 1, wherein
the one or more programs further include instructions for, in a case where a plurality of the objects exist in the training region, obtaining the position information for each of the plurality of objects.

13. The image processing apparatus according to claim 1, wherein
the learning model is a model in which information related to each position in the training region is represented in at least any one format among a multi-layer neural network, a three-dimensional grid, a three-dimensional grid configured in an octree structure, a group of tetrahedrons, a three-dimensional point cloud, and 3D Gaussian splatting.

14. The image processing apparatus according to claim 1, wherein
the spatial information contains at least one of information on a density, information on a signed distance from a surface of the object, information on a color, and information on a color for each of a plurality of directions, at each of a plurality of positions in the training region.

15. The image processing apparatus according to claim 1, wherein
the one or more programs further include instructions for:
obtaining information on a virtual viewpoint; and
generating a virtual viewpoint image representing a view from the virtual viewpoint based on the spatial information obtained as a result of training the learning model and the information on the virtual viewpoint.

16. An image processing method comprising the steps of:
obtaining a plurality of images obtained by image-capturing a three-dimensional space containing an object from a plurality of directions;
analyzing the images to obtain an image feature related to each of the images;
obtaining position information indicating a position of the object; and
setting a parameter in a learning model to estimate spatial information related to a training region contained in the three-dimensional space, based on the position information and the image feature.

17. A non-transitory computer readable storage medium storing a program for causing a computer to perform a control method of an image processing apparatus, the control method comprising the steps of:
obtaining a plurality of images obtained by image-capturing a three-dimensional space containing an object from a plurality of directions;
analyzing the images to obtain an image feature related to each of the images;
obtaining position information indicating a position of the object; and
setting a parameter in a learning model to estimate spatial information related to a training region contained in the three-dimensional space, based on the position information and the image feature.
